(19) United States
(12) Patent Application Publication
(10) Pub. No.: US 2018/0343845 A1
(43) Pub. Date: Dec. 6, 2018

(54) FISHING LINE WHEEL PROVIDED WITH FISHING SIGNAL DEVICE

(71) Applicant: NINGBO ZHONGYUAN ALLJOY FISHING TACKLE CO., LTD., Zhejiang (CN)

(72) Inventor: Zhicheng SHEN, Zhejiang (CN)

(73) Assignee: NINGBO ZHONGYUAN ALLJOY FISHING TACKLE CO., LTD., Zhejiang (CN)

(21) Appl. No.: 15/774,999

(22) PCT Filed: Jan. 26, 2016
(86) PCT No.: PCT/CN2016/072187

§ 371 Date: May 9, 2018

(30) Foreign Application Priority Data
Nov. 13, 2015 (CN) 201510773616.7
Nov. 13, 2015 (CN) 201520902358.3

(51) Int. Cl. A01K 97/12; A01K 89/027; A01K 89/033; A01K 89/01

(52) U.S. Cl. CPC A01K 97/125; A01K 89/0122; A01K 89/033; A01K 89/0275

(57) ABSTRACT

A fishing line wheel provided with a fishing signal device, the fishing signal device comprises an electronic control portion, an alarm switch portion, and an alarm starting portion. The alarm starting portion comprises a mute ring lining (21), a mute ring (22), a reaction bird piece (23), a bird piece reset seat (24), and a reset seat spring (25). The reaction bird piece is a long body and comprises a mounting hole (231), a limiting hole (232), a mute ring clamping protrusion (233), and a spring catch (234). The mounting hole is a kidney-shaped hole. The mute ring clamping protrusion and the spring catch are located at two ends of the reaction bird piece respectively. The limiting hole is located between the mounting hole and the spring catch. In addition, a reset seat arc-shaped groove is formed in one side of the bird piece reset seat, and a spring placement hole is formed in the other side of the bird piece reset seat. A limiting clamping protrusion is disposed on the surface of the bird piece reset seat connected t0 the reaction bird piece. One end of the reset seat spring is inserted into the spring placement hole, and the other end of the reset seat spring is connected to the spring catch. By means of the fishing line wheel provided with a fishing signal device, the situation that a fish swallows a bait is effectively prompted, a user can withdraw a line in proper time to hook a big fish, and the fishing fun is improved; existing components are flexibly used, and costs of the technical enhancement are low.

### TECHNICAL FIELD

The invention relates to a fishing line wheel; specifically, it relates to a fishing line wheel provided with fishing signal device that can learn about the bait eating conditions of fish.

### BACKGROUND ART

The fishing line wheel comprises a fishing line wheel body, a winding reel for coiling and a rotor, the said fishing line wheel body comprises a fishing rod mounting base part, a frame part and a cover body part that can be mounted to the fishing rod, the said frame part is provided with an accommodating space for installing the rotational structure of the rotor as well as other structures, the said cover body part is for covering the accommodating space of the frame part; the said winding reel is installed at the fishing line wheel body, that can move back and forth relative to the fishing line wheel body; and the said rotor is installed at the fishing line wheel body in a rotatable way, for winding the fishing line to the winding reel. For common design, look at the fishing line wheel from the front, when winding the fishing line, the rotor rotates clockwise, as is shown in FIG. 1, and the reaction bird piece 90 (as is shown by the solid line) is at the side of the center of the circle under the action of the mute ring; when the fishing line is wound and reaches the state of waiting for fish to eat the bait, due to small radian rotation of the rotor, the reaction bird piece 90 (as is shown by the dotted line) moves to the ratchet wheel of the fishing line seat, and the maximum moving distance can meet the extent of clamping with the ratchet gear of the fishing line seat.

When using the fishing line wheel of reaction bird piece structure to fish in real life, generally, whether or not the fishing line shall be wound up shall be judged by observing the dynamic status of the fishing line or through the sound of the bell hung on the fishing rod; however, the optimal opportunity of winding up the line is often lost due to inaccurate judgment, enabling the fish hooked to run away, lack of the fun of fishing. This is because the fishing line wheel is not arranged with an effective fishing signal device. Therefore, further improvement shall be made to the fishing line wheel of the structure of a reaction bird piece of the existing technology.

### CONTENTS OF THE INVENTION

As to the above deficiencies, the invention intends to solve the existing technological problems, so as to provide a fishing line wheel provided with fishing signal device.

To achieve the above purpose, the invention adopts the following technical solution:

A fishing line wheel provided with fishing signal device, comprising a fishing line wheel body, a winding reel, a transmission gear and a rotor, the said fishing line wheel body comprises a fishing rod mounting base part, a frame part and a cover body part, the said fishing line wheel further comprises a fishing signal device, and the said fishing signal device further comprises: an electric controller, an alarm switch part and an alarm initiator, and the said alarm initiator comprises: a mute ring lining and a mute ring, and the said alarm initiator further comprises: a reaction bird piece, a bird piece reset seat and a reset seat spring, wherein,

The said reaction bird piece is a long body, comprising a mounting hole, a limiting hole, a mute ring clamping protrusion and a spring catch,

The said mounting hole is a waist-type hole, located in the middle of the said reaction bird piece;

The said mute ring clamping protrusion and spring catch are respectively located at both ends of the reaction bird piece;

The said limiting hole is a waist-type hole, located between the said mounting hole and the said spring catch,

The said reaction bird piece, mounting hole, limiting hole, mute ring clamping protrusion and spring catch are made into one piece by molding;

Besides, one side of the said bird piece reset seat is a reset seat arc-shaped groove, while the other side is opened with a spring emplacement hole, and the side where the said bird piece reset seat is connected with the said reaction bird piece is arranged with a spacing clip;

The said reset seat spring is a compression spring, one end of the said reset seat spring is inserted in the said spring emplacement hole, while the other end of the said reset seat spring protruding from the spring emplacement hole is connected with the said spring catch.

As to the fishing line wheel stated by the preferred embodiment of the invention, the said alarm switch part comprises: an alarm switch dial ring, an alarm switch tension spring and an alarm switch copper sheet part, wherein,

The said alarm switch dial ring comprises a ring holder and a ring dial, the said ring holder is connected with the said mute ring lining, and the said ring dial is connected with the said alarm switch copper sheet part flexibly;

The said alarm switch tension spring is an extension spring, one end of the said alarm switch tension spring is connected with the said ring dial, while the other end is connected with the said fishing line wheel body;

The said alarm switch copper sheet part is the combination of two copper sheets, the said alarm switch copper sheet part is assembled at the said fishing line wheel body, one end of the said alarm switch copper sheet part is connected with the ring dial of the said alarm switch dial ring flexibly, and the other end is connected with the said electric controller.

As to the fishing line wheel stated by the preferred embodiment of the invention, the said electric controller comprises a power supply part and a controller, the said controller is connected with the said frame part, and the said controller comprises a waterproof ring, a circuit board combination, a button, a buzzer and an end cover.

As to the fishing line wheel stated by the preferred embodiment of the invention, the said controller further comprises two power supply connectors, the said two power supply connectors are connected with the said circuit board combination via electric wire, the said two power supply connectors are assembled to the said frame part, and one end of the said two power supply connectors face the said cover body part;

Besides, the said power supply part is connected with the said cover body part, and the said power supply part comprises at least one battery, two battery springs and two power contacts,

The said two battery springs are respectively assembled at both ends of the battery accommodating space of the said cover body part, and middle of the said two battery springs are connected with at least one of the said battery;

The said two power contacts are assembled at the said cover body part, corresponding to the positions of the said two power supply connectors, and the said two power contacts are connected with the said two battery springs.

As to the fishing line wheel stated by the preferred embodiment of the invention, the said circuit board combination comprises a microcontroller, for controlling the buzzer.

Since the above technical features are adopted, compared with the existing technology, the invention has the following superiorities and positive effects:

Firstly, the invention can effectively remind that a fish is hooked, the fisherman can wind up the line at the most appropriate time, catch big fish, and raise the fun of fishing;

Secondly, the invention uses the existing components flexibly, technology is promoted, with low cost;

Thirdly, since the electric controller of the invention is separately placed, shape of the fishing line wheel is more flexible, with more aesthetic appearance.

Of course, any embodiments implementing the contents of the invention are not required to have all of the above technical effects.

### DESCRIPTION OF FIGURES

FIG. 1 shows a diagram where the reaction bird piece of the fishing line wheel in the existing technology moves;

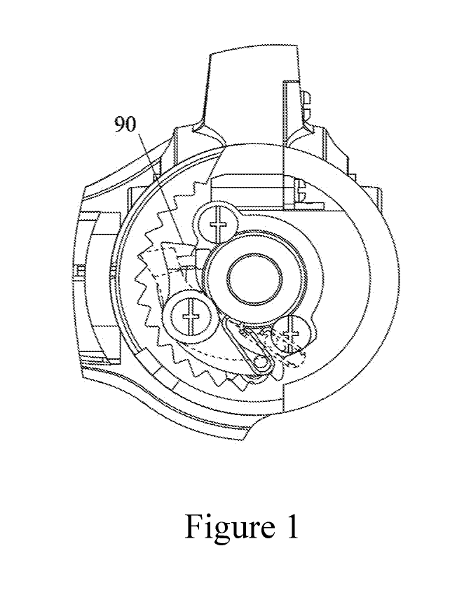

FIG. 2 shows a diagram of the application where the fishing line wheel body and the fishing signal device are separated in an explosive way;

FIG. 3 shows a diagram where the alarm switch part is separated from the alarm initiator in an explosive way;

FIG. 4 shows a diagram of the reaction bird piece, bird piece reset seat and reset seat spring;

FIG. 5 shows a diagram of the power supply connectors;

FIG. 6 shows a diagram of the power contacts;

FIG. 7 shows a diagram of the position of the reaction bird piece of the application when the fishing line wheel conducts clockwise rotation;

FIG. 8 shows a diagram of the moving location and angle of the reaction bird piece of the application;

FIG. 9 shows a diagram where the reaction bird piece of the application is pushed by the ratchet gear of the fishing line seat;

FIG. 10 shows a work flow diagram of the application;

FIG. 11 shows a circuit diagram of the application.

### SPECIFIC EMBODIMENTS

The following is the detailed description of some preferred embodiments of this invention according to the figures herein; however, this invention is not limited to these embodiments. The invention covers any replacements, modifications, equivalent methods and proposals made to the essence and scope of the invention. To enable the public to learn about the invention thoroughly, specific details are described in the preferred embodiments of the invention below; while technicians of this field can totally understand the invention without the description of such details. Besides, in order not to cause unnecessary confusion to the essence of the invention, well-known methods, processes, flows and elements, etc. are not described in detail.

General spinning fishing line wheel comprises a fishing line wheel body, a winding reel for coiling, a transmission gear and a rotor, the said fishing line wheel body comprises a fishing rod mounting base part 101, a frame part 102 and a cover body part 103, the said cover body part 103 is for covering the accommodating space of the frame part 102; the said winding reel is installed at the fishing line wheel body, that can move back and forth relative to the fishing line wheel body; and the said rotor is installed at the fishing line wheel body in a rotatable way, for winding the fishing line to the winding reel; when it comes to usage, before throwing the fishing line, switch the fishing line guide arm from the state of being intertwined by the fishing line to the state of setting out the fishing line; in this state, grapple the fishing line with the forefinger of the hand holding the fishing rod and throw the fishing rod simultaneously. In this way, the fishing line will then fly out due to the weight of the hook component. After throwing, maintain the fishing line guide arm at the state of setting out the fishing line till the hook component reaches the fishing place in the water, and reverse the handle towards the fishing line winding direction in such state, and the rotor will rotate towards the fishing line winding direction. When the rotor rotates towards the fishing line winding direction, the fishing line guide arm will be reset by the guide arm flipping structure to the fishing line winding state. When the fishing line is intertwined in place, wait for the fish to be hooked.

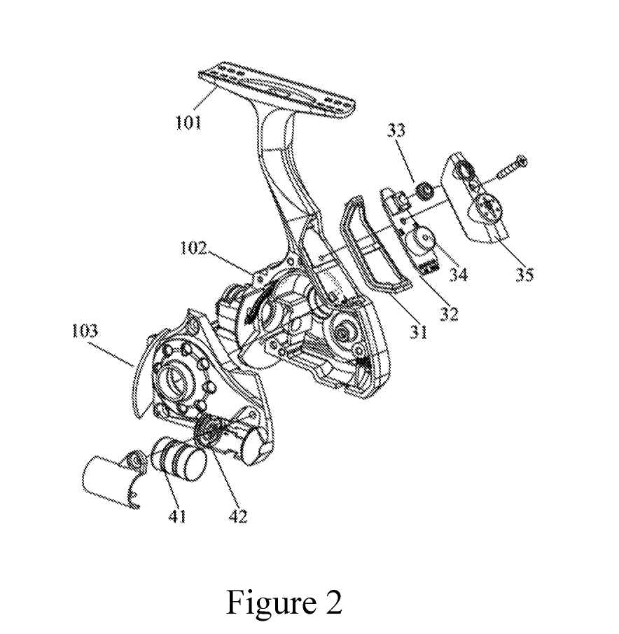

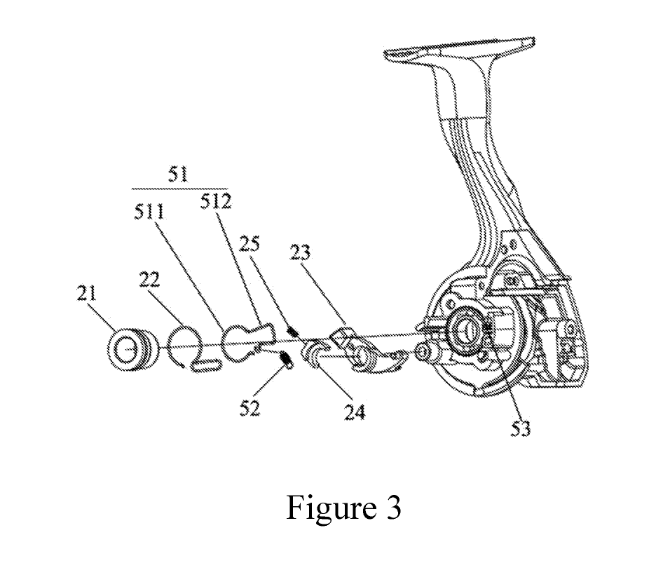

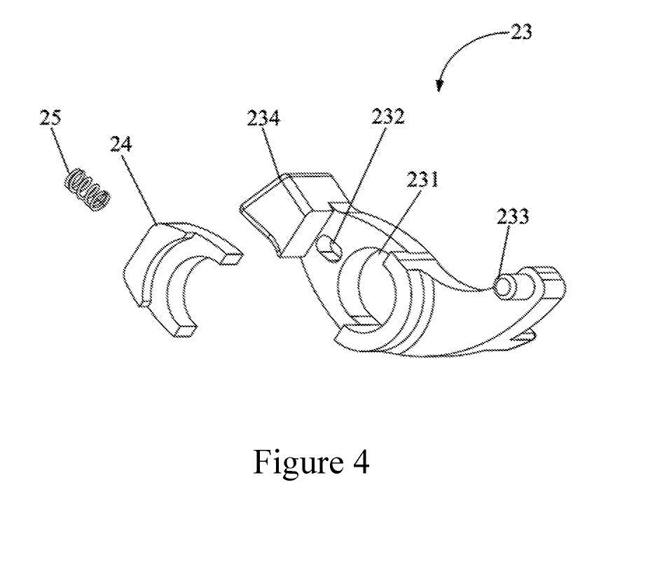

Please refer to FIG. 2, FIG. 3 and FIG. 4, diagrams where the fishing line wheel body is separated from the fishing signal device in an explosive way. The fishing line wheel further comprises a fishing signal device, the said fishing signal device further comprises: an electric controller, an alarm switch part and an alarm initiator, and the said alarm initiator comprises: a mute ring lining 21, a mute ring 22, a reaction bird piece 23, a bird piece reset seat 24 and a reset seat spring 25; where, the said reaction bird piece 23 is a long body, the said reaction bird piece 23 comprises a mounting hole 231, a limiting hole 232, a mute ring clamping protrusion 233 and a spring catch 234; the said mounting hole 231 is a waist-type hole, the said mounting hole 231 lies in the middle of the said reaction bird piece 23; when assembled, the said mounting hole 231 sheathes the post of the fishing line wheel body, spacing the said reaction bird piece 23 with a screw, the reaction bird piece 23 installed can not only rotate, but move within the waist-type hole of the mounting hole 231; the said mute ring clamping protrusion 233 and spring catch 234 are respectively located at both ends of the said reaction bird piece 23, the said mute ring clamping protrusion 233 plays the role of driving the reaction bird piece 23 to rotate after bring connected with the mute ring 22 and accepting the action of the mute ring 22; the said limiting hole 232 is a waist-type hole, lying between the said mounting hole 231 and the said spring catch 234; and the said reaction bird piece 23, mounting hole 231, limiting hole 232, mute ring clamping protrusion 233 and spring catch 234 are made into one piece by molding.

Besides, as is shown by FIG. 4, one side of the said bird piece reset seat 24 is a reset seat arc-shaped groove, after being connected with the reaction bird piece 23, the reset seat arc-shaped groove embraces the arc portion of the reaction bird piece 23, surrounding around the screw; while the other side is opened with a spring emplacement hole (not shown by the figure), and the side where the bird piece reset seat 24 is connected with the said reaction bird piece 23 is arranged with a spacing clip (not shown by the figure); during the assembly, place the spacing clip into the said limiting hole 232, so as to limit the moving trail of the said bird piece reset seat 24; the said spacing clip can either be a circular cylinder, square or other shapes, so long as it can slide or move smoothly in the limiting hole 232, without deflection; the said reset seat spring 25 is a compression spring, one end of which is inserted in the said spring emplacement hole, while the other end protruding from the said spring emplacement hole is connected with the said spring catch 234. The said spring catch 234 has two functions, one is serving as the force applying plane of the reset seat spring 25, which cooperates with the bird piece reset seat 24 to compress the reset seat spring 25; the other function is clamping with and driven by the ratchet gear of the fishing line seat, so as to enable the reaction bird piece 23 to move; after assembly, the reset seat spring 25 is relaxed provided that there is no external force, pushing the bird piece reset seat 24 to the arc portion of the reaction bird piece 23, forming embraced shape.

Besides, please refer to FIG. 3, the diagram where the alarm switch part is separated from the alarm initiator in an explosive way; and the said alarm switch part comprises: an alarm switch dial ring 51, an alarm switch tension spring 52 and an alarm switch copper sheet part 53; where, the said alarm switch dial ring 51 comprises a ring holder 511 and a ring dial 512; the said ring holder 511 is connected with the said mute ring lining 21, the said ring dial 512 is connected with the said alarm switch copper sheet part 53 flexibly; the said alarm switch tension spring 52 is a tension spring, one end of the said alarm switch tension spring 52 is connected with the said ring dial 512, while the other end of the said alarm switch tension spring 52 is connected with the said fishing line wheel body, function of the alarm switch tension spring 52 is to reset the alarm switch dial ring 51 to the position where there is no stress; the said alarm switch copper sheet part 53 is the combination of two copper sheets, the said alarm switch copper sheet part 53 is assembled on the said fishing line wheel body, the two copper sheets will not contact without external force, one end of one copper sheet of the said alarm switch copper sheet part 53 is connected with the ring dial 512 of the said alarm switch dial ring 51 flexibly, accepting the thrust force of the ring dial 512 and approaches to the other copper sheet, and the other end of the two copper sheets of said alarm switch copper sheet part 53 are respectively connected with the said electric controller. When the ring dial 512 of the alarm switch dial ring 51 pushes one copper sheet of the alarm switch copper sheet part 53 to approach to the other copper sheet, and makes the two copper sheets to rely on in together, the alarm switch will trigger.

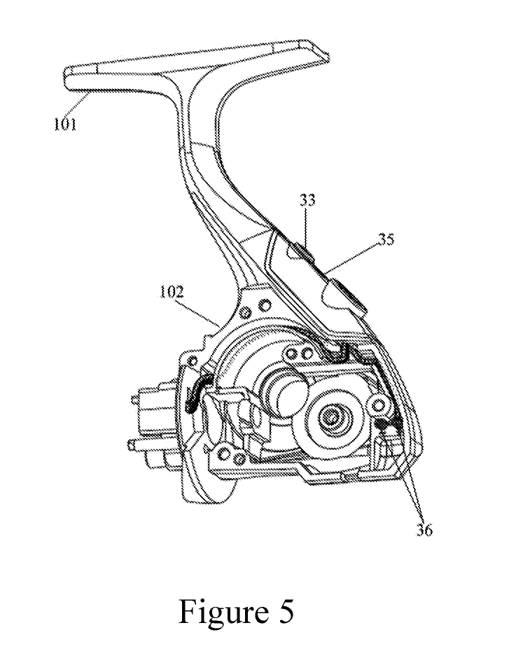

Besides, please refer to FIG. 2, the diagram where the fishing line wheel body is separated from the fishing signal device in an explosive way, the said electric controller comprises a power supply part and a controller, the said controller is connected with the said frame part 102, and the said controller comprises a waterproof ring 31, a circuit board combination 32, a button 33, a buzzer 34 and an end cover 35. The shape where the appearance of the waterproof ring 31 cooperates with the assembly position of the frame part 102 presents water from entering the circuit board combination 32; the circuit board combination 32 is installed with a button 33 and a buzzer 34, then covered with an end cover 35, locked to the frame part 102 with a screw; please refer to FIG. 5 at the same time, the said controller further comprises two power supply connectors 36, which are connected with the said circuit board combination 32 via electric wire, and assembled at the said frame part 102, one end of the said two power supply connectors 36 face the said cover body part 103; the power supply connector 36 is an elastic body, which can either be spring, shrapnel or other elastic bodies, so long as it can sink in proper time when pressed and contact with the pressure applying body; in this embodiment, the power supply connector 36 is a compression spring; however, it can't be used for restricting this application.

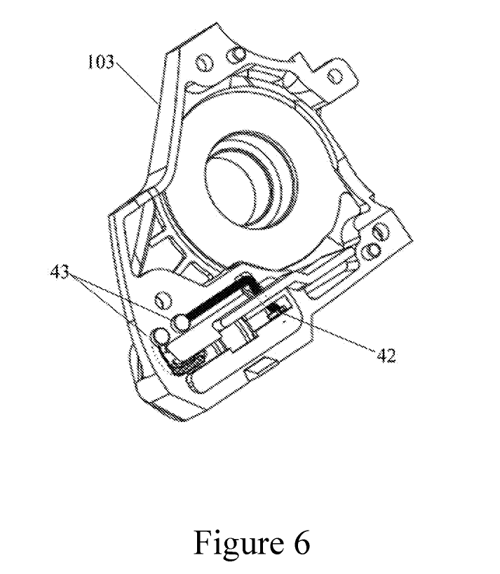

Besides, please refer to FIG. 2 and FIG. 6 in the meantime; the said power supply part is connected with the said cover body part 103, the said power supply part comprises at least one battery 41, two battery springs 42 and two power contacts 43, the said two battery springs 42 are respectively assembled at both ends of the battery accommodating space of the said cover body part 103, and the battery accommodating space is covered shall be covered with a battery cover, so as to prevent water immersion and protect power source; middle of the said two battery springs 42 are connected with at least one of the said battery 41; in this application, there are three batteries 41; however, they can't be used to restrict the application; the said two power contacts 43 are assembled at the said cover body part 103, corresponding to the positions of the said two power supply connectors 36, and the said two power contacts 43 are connected with the said two battery springs 42 one to one; after the cover body part 103 is assembled to the frame part 102, the two power contacts 43 will be connected with the two power supply connectors 36 accordingly, and power is switched on.

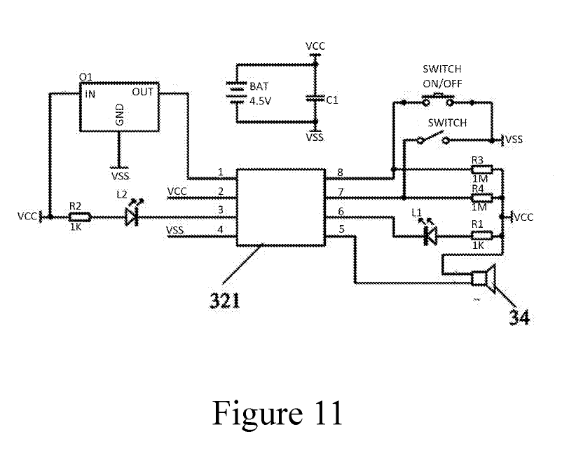

In respect of control, please refer to FIG. 11, circuit diagram of the application; as is shown in the figure, the said circuit board combination 32 comprises a microcontroller 321, for controlling the electric quantity of the buzzer 34 and detecting the electric quantity of the battery 41; another major task is to give alarm and flash in good time according to the contents set, reminding anglers whether to wind up the fishing line.

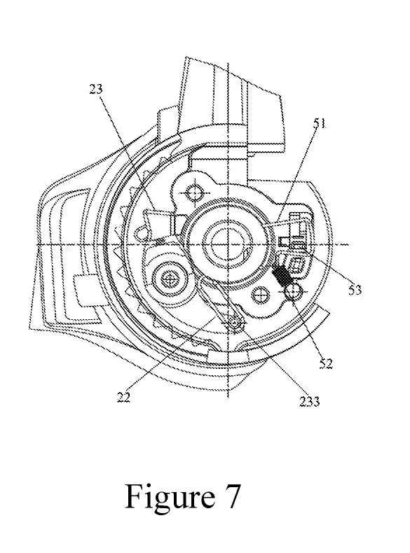

Next, operating principle of the application will be described, please refer to FIG. 7, the position diagram of the reaction bird piece when the fishing line wheel of the application conducts clockwise rotation; namely, after throwing, maintain the fishing line guide arm at the state of setting out the fishing line till the hook component reaches the fishing place in the water, and enable the handle to reverse towards the fishing line winding direction in such state, and the rotor will rotate towards the fishing line winding direction. When the rotor rotates towards the fishing line winding direction, the fishing line guide arm will be reset by the guide arm flipping structure to the fishing line winding state. Continue to rotate the handle towards the fishing line winding direction, as is shown by the figure, and position of the reaction bird piece 23 will be close to the side which is near the center.

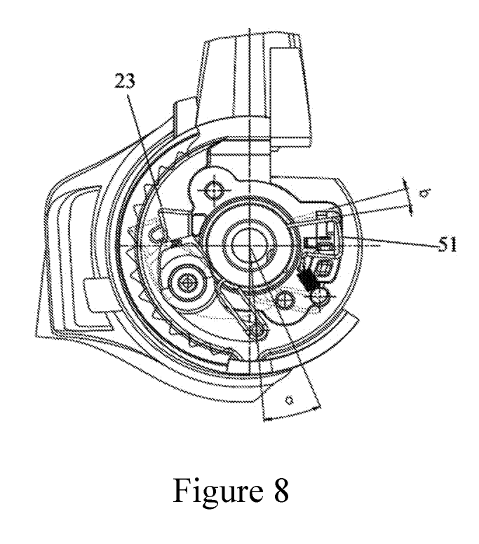

Next, please refer to FIG. 8, the mobile location angle diagram of the reaction bird piece of the application; after the handle conducts rotation towards the fishing line winding direction, is in place, waits for the fish to eat the bait, and all is ready, the fishermen shall press the button 33 of the controller and start the fishing signal device; then, the buzzer 34 will send out a sound, and the LED on the circuit board combination 32 will send a flash. As is shown by the figure, angle a represents the angle rotated by the fishing line seat, when the reaction bird piece 23 moves from the solid line position (initial position) to the dotted line position (clip into the ratchet gear of the fishing line seat); angle b represents the angle when the alarm switch dial ring 51 triggers the alarm switch copper sheet part, angle a is greater than angle b; what shall be noted is that, when all is ready, reaction bird piece 23 may either be in the position of the solid line, or be in the position of the dotted line, or between the two; however, fishing line seat deflection of such degree will no cause alarm.

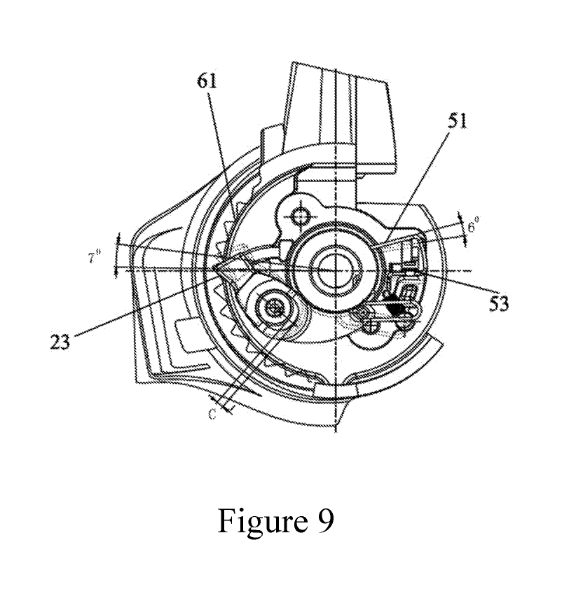

However, when fish starts to eat the bait, pulling the fishing line, giving rise to rotary movement of the fishing line seat, first of all, as is shown by FIG. 8, angle 8 forms; if the fish continues to pull the fishing line, enabling the fishing line seat to continue to rotate, please refer to FIG. 9, the diagram where the reaction bird piece of the application is pushed by the ratchet gear of the fishing line seat, the ratchet gear 61 of the fishing line seat will push the reaction bird piece 23 to deflect for 7° maximally (namely from the position of the dotted line to the position of the solid line), namely, from one end of the waist-type hole to the other end of the waist-type hole, the distance C as is shown by the figure; while the alarm switch dial ring 51 can push the alarm switch copper sheet part 53 to deflect for 6° maximally, and during the deflection for 6°, the two copper sheets of the alarm switch copper sheet part 53 contact and switch on; when the two copper sheets contact and switch on for 0.1 s, the buzzer 34 sends out sound continuously, the LED on the circuit board combination 32 flashes continuously, notifying the fisherman that a big fish is hooked, and the fishing line can be taken up; otherwise, if the two copper sheets contact and switch on for less than 0.1 s, the buzzer 34 will send out sound for four times, and the LED on the circuit board combination 32 will flash. What shall be noted is that, generally, ratchet gear 61 of the fishing line seat has 36 teeth; therefore, for every 10 degrees, it will jump to the next tooth; in this application, the reaction bird piece 23 can deflect for 7° maximally; thus, it will not jump to the next tooth. When the fisherman starts to rotate the fishing line wheel and wind up the fishing line, the ratchet gear 61 of the fishing line seat will conduct clockwise rotation, the strength imposed by the ratchet gear 61 of the fishing line seat on the reaction bird piece 23 is eliminated, the reset seat spring 25 relaxes; when applying force on the spring catch 234 and bird piece reset seat 24, the bird piece reset seat 24 resists against the threaded rod and can't move, and the relaxation force of the reset seat spring 25 drives the reaction bird piece 23 to return to the position before being pushed.

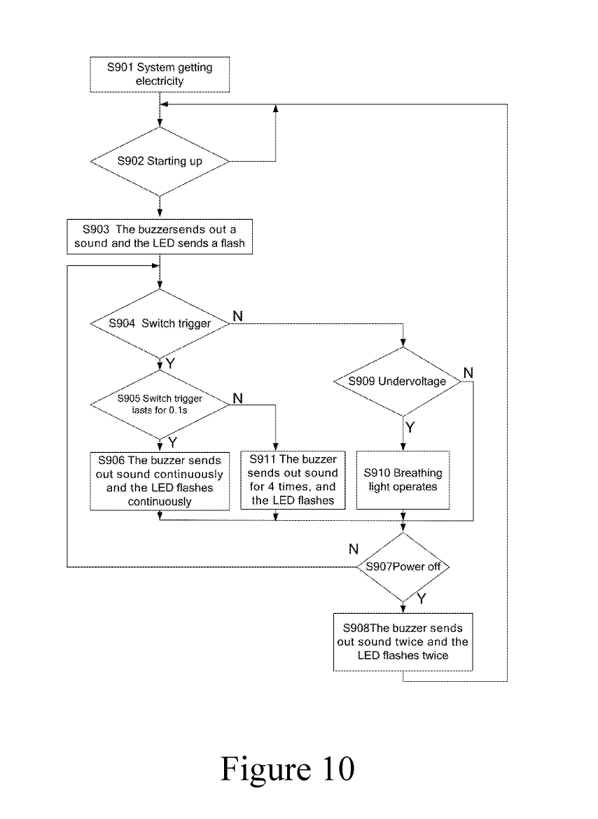

Please refer to FIG. 10, the work flow diagram of the application comprises Step S901 System getting electricity, namely, batteries 41 are loaded to the battery accommodating space of the cover body part 103; Step S902 Starting up, press the button 33, switch on the power and start up the fishing signal device; Step S903 The buzzer sends out a sound and the LED sends a flash, waiting for fish to eat the bait; Step S904 Switch trigger, namely, the two copper sheets of the alarm switch copper sheet part 53 contact and switch on; Step S905 Switch trigger lasts for 0.1 s, namely, the two copper sheets of the alarm switch copper sheet part 53 contact and switch on for 0.1 s; Step S906 The buzzer sends out sound continuously and the LED flashes continuously, fish is hooked and the fishing line can be wound up; besides, the fisherman does not want to fish and wants to go home; Step S907 Power off, press the button 33; Step S908 The buzzer sends out sound twice and the LED flashes twice, and power is cut off. Besides, between the Step S903 and Step S904, there is also Step S909 Undervoltage, namely, electric quantity of batteries 41 is insufficient, Step S910 Breathing light operates, the LED changes gradually from bright to dim, notifying the fisherman to change batteries 41. Besides, between the Step S904 and Step S905, there is also Step S911 the buzzer sends out sound for 4 times, and the LED flashes, indicating that the fish is eating the bait; however, the bait is pulled for less than 0.1 s; if such action is repeated for several times, maybe the bait is eaten up by the fish.

In conclusion, since the above technical features are adopted, compared with the existing technology, the invention has the following superiorities and positive effects:

Firstly, the invention can effectively remind that a fish is hooked, the fisherman can wind up the line at the most appropriate time, catch big fish, and raise the fun of fishing;

Secondly, the invention uses the existing components flexibly, technology is promoted, with low cost;

Thirdly, since the electric controller of the invention is separately placed, shape of the fishing line wheel is more flexible, with more aesthetic appearance.

The preferred embodiments of the invention are only used for facilitating the elaboration. The preferred embodiments have neither narrated all the details, nor restricted the invention to only the specific embodiments mentioned. Evidently, the embodiments can be modified and changed a lot as per the contents of the invention. The specification has selected and given specific description to these embodiments, so as to interpret the principle and practical application of the invention in a better way, thus enabling technicians of the technical field to utilize the invention in a better way. The invention is only restricted by the claims as well as all of its coverage and equivalents. What disclosed above are only the preferred embodiments of the invention; however, they are not used for restricting the invention, equivalent changes and alterations made by any technician skillful in this field without going against the spiritual connotation of the invention shall fall into the scope of protection.

What is claimed is:

1. A fishing line wheel provided with a fishing signal device, comprising: a fishing line wheel body, a winding reel, a transmission gear and a rotor; the fishing line wheel body comprises a fishing rod mounting base part, a frame part and a cover body part; the fishing line wheel further comprises the fishing signal device, the fishing signal device further comprises: an electric controller, an alarm switch part and an alarm initiation part, and the alarm initiator comprises: a mute ring lining and a mute ring, characterized in that, the ala ii initiator further comprises: a reaction bird piece, a bird piece reset seat and a reset seat spring, wherein,
the reaction bird piece is a long body, comprising a mounting hole, a limiting hole, a mute ring clamping protrusion and a spring catch,
the mounting hole is a waist-type hole, located in the middle of the reaction bird piece;
the mute ring clamping protrusion and the spring catch are respectively located at both ends of the reaction bird piece;
the limiting hole is a waist-type hole, located between the mounting hole and the spring catch,
the reaction bird piece, the mounting hole, the limiting hole, the mute ring clamping protrusion and the spring catch are made into one piece by molding;
besides, one side of the bird piece reset seat is a reset seat arc-shaped groove, while the other side is opened with a spring emplacement hole, and the side where the bird piece reset seat is connected with the reaction bird piece is arranged with a spacing clip;
the reset seat spring is a compression spring, one end of the reset seat spring is inserted in the spring emplacement hole, while the other of the reset seat spring protruding from the spring emplacement hole is connected with the spring catch.

2. The fishing line wheel according to claim 1, characterized in that, the alarm switch part comprises: an alarm switch dial ring, an alarm switch tension spring and an alarm switch copper sheet part, wherein,
the alarm switch dial ring comprises a ring holder and a ring dial, the ring holder is connected with the mute ring lining, and the ring dial is connected with the alarm switch copper sheet part flexibly;
the alarm switch tension spring is an extension spring, one end of the alarm switch tension spring is connected with the ring dial, while the other end is connected with the fishing line wheel body;
the alarm switch copper sheet part is a combination of two copper sheets, assembled to the fishing line wheel body, one end of the alarm switch copper sheet part is connected with the ring dial of the alarm switch dial ring flexibly, and the other end is connected with the electric controller.

3. The fishing line wheel according to claim 1, characterized in that, the electric controller comprises a power supply part and a controller, the controller is connected with the frame part, and the controller comprises a waterproof ring, a circuit board combination, a button, a buzzer and an end cover.

4. The fishing line wheel according to claim 3, characterized in that, the controller further comprises two power supply connectors, the two power supply connectors are connected with the circuit board combination via an electric wire, the two power supply connectors are assembled at the frame part, and one end of the two power supply connectors face the cover body part;
besides, the power supply part is connected with the cover body part, and the power supply part comprises at least one battery, two battery springs and two power contacts,
the two battery springs are respectively assembled at both ends of the battery accommodating space of the cover body part, and a middle of the two battery springs is connected with at least one of the battery;
the two power contacts are assembled at the cover body part, corresponding to the positions of the two power supply connectors, and the two power contacts are connected with two of the battery springs.

5. The fishing line wheel according to claim 3, characterized in that, the circuit board combination comprises a microcontroller, for controlling the buzzer.
